(19) United States
(12) Patent Application Publication
(10) Pub. No.: US 2015/0205534 A1
(43) Pub. Date: Jul. 23, 2015

(54) CONTROLLER, SOLID-STATE DRIVE AND CONTROL METHOD

(71) Applicant: KABUSHIKI KAISHA TOSHIBA, Minato-ku (JP)

(72) Inventors: Kouji WATANABE, Tokyo (JP); Takashi Ide, Yokohama-shi (JP); Kiyotaka Iwasaki, Kawasaki-shi (JP)

(73) Assignee: KABUSHIKI KAISHA TOSHIBA, Minato-ku (JP)

(21) Appl. No.: 14/200,152

(22) Filed: Mar. 7, 2014

Related U.S. Application Data
(60) Provisional application No. 61/928,459, filed on Jan. 17, 2014.

(51) Int. Cl. G06F 3/06

(52) U.S. Cl. CPC G06F 3/0613; G06F 3/0688; G06F 3/0659

(57) ABSTRACT

According to one embodiment, a controller includes a first command queuing part corresponding to a first bank, the first command queuing part queuing commands, a second command queuing part corresponding to a second bank, the second command queuing part queuing commands, and a bank control part which is configured to generate a first bound command by binding at least two commands in the first command queuing part, generate a second bound command by binding at least two commands in the second command queuing part, transfer the first bound command as an unit of an interleave operation between the first and second banks to the first bank, and transfer the second bound command as an unit of the interleave operation to the second bank.

### CROSS-REFERENCE TO RELATED APPLICATIONS

This application claims the benefit of U.S. Provisional Application No. 61/928,459, filed Jan. 17, 2014, the entire contents of which are incorporated herein by reference.

### FIELD

Embodiments described herein relate generally to a controller, a solid-state drive (SSD) and a control method.

### BACKGROUND

In a memory system provided with a plurality of banks serving as a data storage device and controller configured to control operations such as data read, data write, data erasure and the like to be carried out with respect to the plurality of banks, an interleave operation configured to operate the plurality of banks in parallel is a technique effective for improvement of throughput.

For example, when, once transfer of a first command from the controller to a first bank is complete, a busy time during which the first command is to be executed occurs in the first bank, if a second command is transferred from the controller to a second bank within the busy time, it is possible to apparently conceal the busy time of the first command when viewed from outside by operating these two banks in parallel.

### BRIEF DESCRIPTION OF THE DRAWINGS

FIG. 1 is a view showing the block configuration of a memory system;

FIG. 2 is a view showing the relationship between a write command and busy time;

FIG. 3 is a view showing the relationship between a read command and busy time;

FIG. 4 is a view showing a controller of FIG. 1;

FIGS. 5 to 7 are views each showing an interleave operation according to a first embodiment;

FIG. 8 and FIG. 9 are views each showing a first example in which an interleave operation is carried out by using a read command and write command forming a pair as a bound command;

FIG. 10 and FIG. 11 are views each showing a second example in which an interleave operation is carried out by using a read command and write command forming a pair as a bound command;

FIG. 12 is a view showing an example in which a bound command is created by a command management part;

FIG. 13 is a view showing a state of the command management part corresponding to the example of FIG. 8 and FIG. 9;

FIG. 14 and FIG. 15 are views each showing an order list management part;

FIG. 16 is a view showing an interleave operation according to a second embodiment;

FIG. 17 and FIG. 18 are views each showing a bank state management part in the example of FIG. 16;

FIG. 19 is a view showing a state of the command management part in the example of FIG. 16;

FIG. 20 is a view showing an interleave operation according to the second embodiment;

FIG. 21 is a view showing the bank state management part in the example of FIG. 20;

FIG. 22 is a view showing an interleave operation according to the second embodiment;

FIG. 23 is a view showing the bank state management part in the example of FIG. 22;

FIG. 24 is a view showing an interleave operation according to the second embodiment;

FIG. 25 is a view showing the bank state management part in the example of FIG. 24;

FIG. 26 is a view showing an interleave operation according to a third embodiment;

FIG. 27 is a view showing the command management part in the example of FIG. 26;

FIG. 28 is a view showing an interleave operation according to a fourth embodiment;

FIG. 29 is a view showing the order list management part in the example of FIG. 28;

FIG. 30 is a flowchart showing an interleave operation according to a fifth embodiment;

FIG. 31 is a view showing an SSD as an application example;

FIG. 32 is a view showing an example of a controller of FIG. 31; and

FIG. 33 is a view showing the relationship between the front- and back-end parts of FIG. 32.

### DETAILED DESCRIPTION

In general, according to one embodiment, a controller comprises: a first command queuing part corresponding to a first bank, the first command queuing part queuing commands, the first bank executing the commands queued in the first command queuing part; a second command queuing part corresponding to a second bank, the second command queuing part queuing commands, the second bank executing the commands queued in the second command queuing part; and a bank control part which is configured to: generate a first bound command by binding at least two commands in the first command queuing part, generate a second bound command by binding at least two commands in the second command queuing part, transfer the first bound command as an unit of an interleave operation between the first and second banks to the first bank, and transfer the second bound command as an unit of the interleave operation to the second bank.

### (Block Configuration)

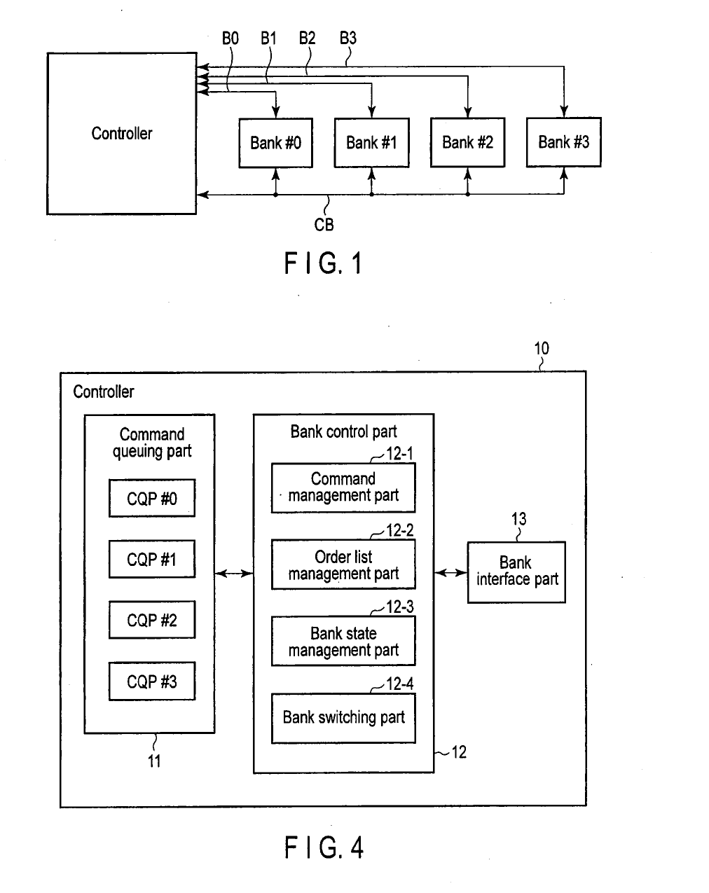

FIG. 1 shows the block configuration of a memory system.

Each of banks #0, #1, #2 and #3 is a data storage device, for example, a NAND flash memory. Although in this example, the number of banks is four, the number is not limited to this. That is, it suffices that the number of banks is two or more.

A controller 10 controls the operations of banks #0, #1, #2 and #3.

Each of B0, B1, B2 and B3 is a dedicated bus provided separately for each of banks #0, #1, #2 and #3.

For example, a signal (for example, a chip enable signal configured to select an active bank) configured to switch banks #0, #1, #2 and #3 is transferred from the controller 10 to each of banks #0, #1, #2 and #3 over each of the dedicated buses B0, B1, B2 and B3.

Further, a signal (for example, a ready/busy signal) configured to convey the state of each of banks #0, #1, #2 and #3 to the controller 10 is transferred from each of banks #0, #1, #2 and #3 to the controller 10 over each of the dedicated buses B0, B1, B2 and B3.

Further, CB is a common bus provided in common with banks #0, #1, #2 and #3.

For example, a command configured to instruct each of banks #0, #1, #2 and #3 to operate is transferred from the controller 10 to each of banks #0, #1, #2 and #3 over the common bus CB.

The command includes a read command, write command, erase command and the like.

The command is transferred over the common bus, and hence other commands cannot be transferred until the transfer of the command is complete.

For example, during a period during which a command is transferred from the controller 10 to bank #0, the common bus CB is in use, and hence a command cannot be transferred from the controller 10 to bank #1, #2 or #3.

Further, in a bank which has received a command, a period during which an operation such as a read operation, write operation, or erase operation is carried out is called the busy time. The busy time continues for a fixed period without intermission even after the transfer of the command is complete.

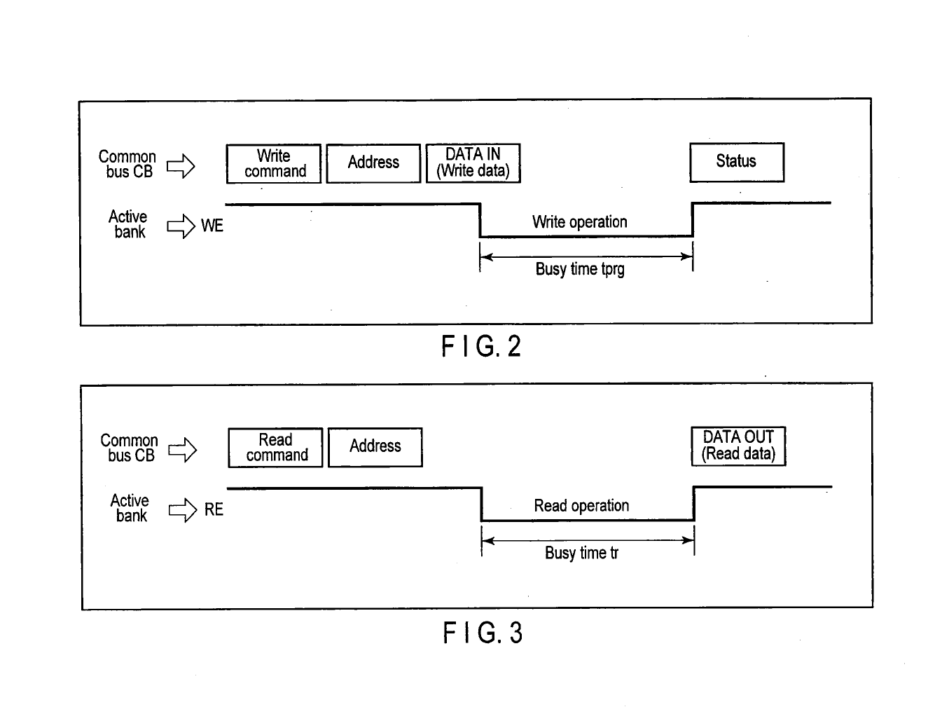

For example, as shown in FIG. 2, a write operation is executed in an active bank after a write command, address and write data are transferred over the common bus CB. The period during which the write operation is executed in the active bank is a busy time tprg. Once the write operation is complete, a status indicating completion of the write operation is transferred to the controller 10 over the common bus CB.

Further, as shown in FIG. 3, a read operation is executed in an active bank after a read command and address are transferred over the common bus CB. The period during which the read operation is executed in the active bank is a busy time tr. Once the read operation is complete, the read data is transferred to the controller 10 over the common bus CB.

In order to improve throughput by an interleave operation in the above-mentioned block configuration, it is advisable, when, for example, a busy time occurs in bank #0, to transfer a command to bank #1 to thereby operate banks #0 and #1 in parallel.

However, in recent years, while the speed of transferring a command has been increased, it has been impossible, for example, to sufficiently shorten the busy time tprg of a write operation. Accordingly, it has become difficult to conceal the busy time inside bank #0 when viewed from outside by means of the transfer time for transfer of a command to bank #1. Particularly, in a multilevel NAND flash memory, the higher the level of an upper bit associated with a write operation, i.e., the greater the number of threshold distributions in a memory cell after a write operation, the longer the busy time is, and hence it is difficult to conceal the busy time by a transfer of one command.

Accordingly, in the following embodiments, a technique of creating a bound command formed by integrating a plurality of commands registered in a command queuing part in the controller 10 into a single command, and executing an interleave operation by using the bound command as one unit is proposed. Thereby, it becomes easy to conceal a busy time in bank #0 by a transfer time for transfer of the bound command to bank #1 when viewed from outside.

Further, a bound command is created for each of a plurality of banks and the order of execution of the interleave operation is controlled, whereby improvement of throughput is achieved.

FIG. 4 shows a controller of FIG. 1.

The controller 10 is provided with command queuing part 11, bank control part 12 and bank interface part 13.

The command queuing part 11 is provided for each of a plurality of banks to be controlled by the controller 10. For example, as shown in FIG. 1, when the controller 10 controls operations of banks #0, #1, #2 and #3, the command queuing part 11 is provided with CQP #0, #1, #2 and #3.

CQPO #0 queues a plurality of commands to be executed in bank #0, CQP #1 queues a plurality of commands to be executed in bank #1, CQP #2 queues a plurality of commands to be executed in bank #2, and CQP #3 queues a plurality of commands to be executed in bank #3.

The bank control part 12 controls an interleave operation for each of banks #0, #1, #2 and #3. For that purpose, the bank control part 12 is provided with a command management part 12-1, order list management part 12-2, bank state management part 12-3 and bank switching part 12-4.

The command management part 12-1 manages, with respect to a plurality of commands queued in the command queuing part 11, the registration order of each command in the command queuing part 11.

Further, the command management part 12-1 creates a bound command formed by integrating a plurality of commands in each of CQP #i (i is one of 0 to 3) into one single command. The bound command serves as a unit of command transfer from the controller 10 to each bank.

Furthermore, the command management part 12-1 manages whether or not each of the plurality of commands queued in the command queuing part 11 is used for a bound command.

The order list management part 12-2 controls the order of executing the interleave operation. For example, as shown in FIG. 1, when an interleave operation is executed by using banks #0, #1, #2 and #3, the order list management part 12-2 manages the order of transferring a bound command to these banks.

The bank state management part 12-3 manages states of a plurality of banks which are objects of the interleave operation. For example, as shown in FIG. 1, when an interleave operation is to be executed by using banks #0, #1, #2 and #3, the bank state management part 12-3 manages whether these banks are busy (command execution state) or ready (command receivable state).

The bank switching part 12-4 selects a bank serving as a transfer destination of a bound command created in the command management part 12-1 on the basis of information on, for example, the order list management part 12-2 and bank state management part 12-3. That is, transfer of a command from the controller 10 to the bank selected by the bank switching part 12-4 is enabled.

The bank interface part 13 functions as an interface with each of banks #0, #1, #2 and #3 as shown in FIG. 1.

### First Embodiment

A first embodiment relates to an example in which a bound command is used as a unit of an interleave operation.

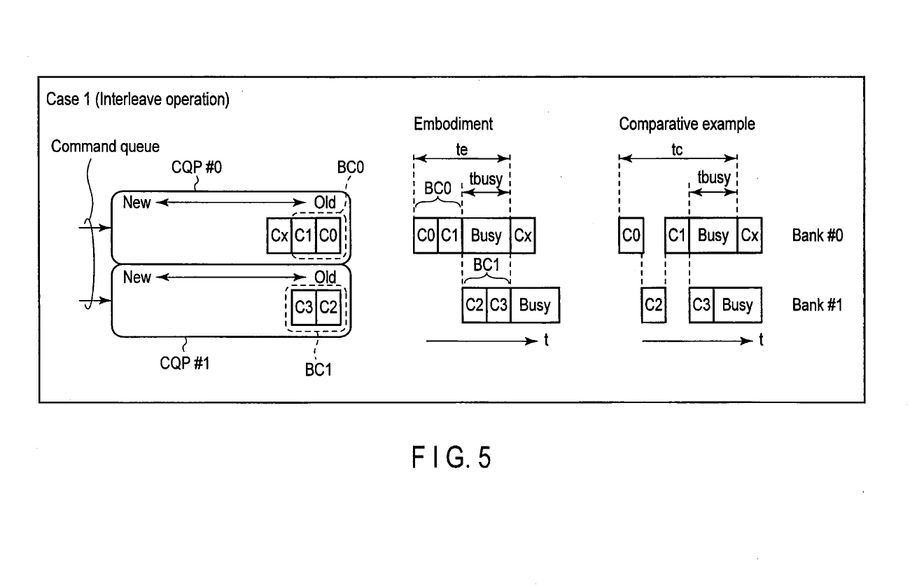

FIG. 5 shows a case 1 of the interleave operation.

In case 1, commands C0, C1 and Cx are queued in CQP #0, and commands C2 and C3 are queued in CQP #1. The order of registration of these commands in the command queuing part is, for example, C0, C1, C2, C3 and Cx. A command early in the registration order is an old command and a command late in the registration order is a new command.

In CQP #0, a bound command BC0 is created by two commands C0 and C1. In CQP #1, a bound command BC1 is created by two commands C2 and C3.

In case 1, first, bank #0 is selected and bound command BC0 is transferred to bank #0. In bank #0, commands C0 and C1 are consecutively executed. A busy time (execution time) of command C1 is expressed as tbusy. Thus, within this busy time tbusy, bank #1 is selected and bound command BC1 is transferred to bank #1.

However, in case 1, each of commands C0 and C2 is assumed to be a command with a short execution time, such as a read command, compaction read command, erase command, or reset command, and each of commands C1 and C3 is assumed to be a command with a long execution time, such as a write command.

In this embodiment, illustration of a busy time of a command with a short execution time is omitted.

In this case, it is possible to conceal busy time tbusy of command C1 in bank #0 by a transfer time for transfer of bound command BC1 to bank #1. Further, in bank #0, it is possible to minimize time to from transfer of bound command BC0 to completion of execution of command C1 to the utmost. Accordingly, it is possible to advance the timing of transfer of command Cx to bank #0.

Conversely, a comparative example is an example of an interleave operation using no bound command. In this example, one command serves as a unit of an interleave operation and hence it is not possible to conceal, for example, busy time tbusy of command C1 in bank #0 by a transfer time for transfer of command C3 to bank #1.

Further, in bank #0, time tc from transfer of command C0 to completion of execution of command C1 is longer than time to in the embodiment. Accordingly, the timing of transfer of command Cx to bank #0 is later than the embodiment.

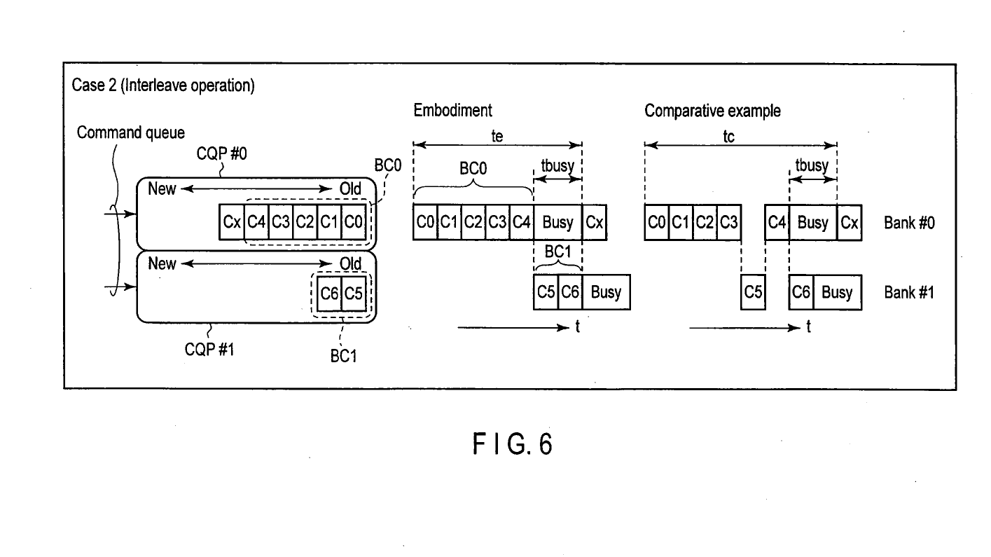

FIG. 6 shows a case 2 of the interleave operation.

In case 2, commands C0 to C4 and Cx are queued in CQP #0, and commands C5 and C6 are queued in CQP #1. The order of registration of these commands in the command queuing part is, for example, C0, C1, C2, C3, C4, C5, C6 and Cx.

In CQP #0, a bound command BC0 is created by the five commands C0 to C4. In CQP #1, a bound command BC1 is created by the two commands C5 and C6.

In case 2, first, bank #0 is selected and bound command BC0 is transferred to bank #0. In bank #0, commands C0 to C4 are consecutively executed. A busy time (execution time) of command C4 is tbusy. Thus, within this busy time tbusy, bank #1 is selected and bound command BC1 is transferred to bank #1.

However, in case 2, each of commands C0 to C3 and C5 is assumed to be a command with a short execution time, such as a read command, compaction read command, erase command, or reset command, and each of commands C4 and C6 is assumed to be a command with a long execution time, such as a write command.

In this embodiment, illustration of a busy time of a command with a short execution time is omitted.

In this case, it is possible to conceal busy time tbusy of command C4 in bank #0 by a transfer time for transfer of bound command BC1 to bank #1. Further, in bank #0, it is possible to minimize the te from transfer of bound command BC0 to completion of execution of command C4 to the utmost. Accordingly, it is possible to advance the timing of transfer of command Cx to bank #0.

Conversely, a comparative example is an example of an interleave operation using no bound command. In this example, as in case 1, one command serves as a unit of an interleave operation and hence it is not possible to conceal, for example, busy time tbusy of command C4 in bank #0 by a transfer time for transfer of command C6 to bank #1.

Further, in bank #0, time tc from transfer of command C0 to completion of execution of command C4 is longer than time te in the embodiment. Accordingly, the timing of transfer of command Cx to bank #0 is later than the embodiment.

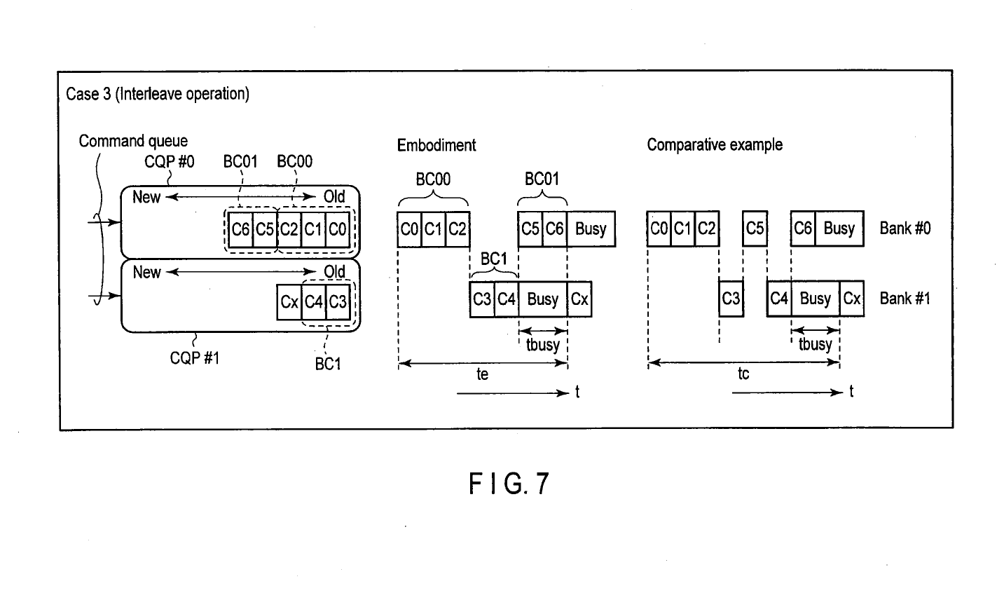

FIG. 7 shows a case 3 of the interleave operation.

In case 3, commands C0 to C2, C5 and C6 are queued in CQP #0, and commands C3, C4 and Cx are queued in CQP #1. The order of registration of these commands in the command queuing part is, for example, C0, C1, C2, C3, C4, C5, C6 and Cx.

In CQP #0, a bound command BC00 is created by the three commands C0 to C2, and a bound command BC01 is created by the two commands C5 and C6. Further, in CQP #1, a bound command BC1 is created by the two commands C3 and C4.

In case 3, first, bank #0 is selected and bound command BC00 is transferred to bank #0. In bank #0, commands C0 to C2 are consecutively executed. Commands C0 to C2 are commands with a short execution time such as a compaction read commands.

In this embodiment, illustration of a busy time of a command with a short execution time is omitted.

Once transfer of commands C0 to C2 is complete, bank #1 is selected and bound command BC1 is transferred to bank #1. In bank #1, commands C3 and C4 are consecutively executed. Command C3 is a command with a short execution time and command C4 is a command with a long execution time.

Thus, during busy time (execution time) tbusy of command C4, bank #0 is selected again and bound command BC01 is transferred to bank #0.

In this case, it is possible to conceal busy time tbusy of command C4 in bank #1 by a transfer time for transfer of bound command BC01 to bank #0. Further, in bank #1, it is possible to minimize time te from transfer of bound command BC00 to completion of execution of command C4 to the utmost. Accordingly, it is possible to advance the timing of transfer of command Cx to bank #1.

Conversely, a comparative example is an example of an interleave operation using no bound command. In this example, as in case 1, one command serves as a unit of an interleave operation and hence it is not possible to conceal, for example, busy time tbusy of command C4 in bank #1 by a transfer time for transfer of command C6 to bank #1.

Further, in bank #1, time tc from transfer of command C0 to completion of execution of command C4 is longer than time te in the embodiment. Accordingly, the timing of transfer of command Cx to bank #1 is later than the embodiment.

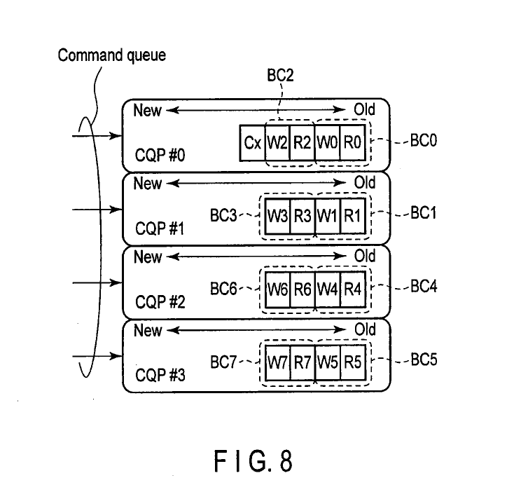

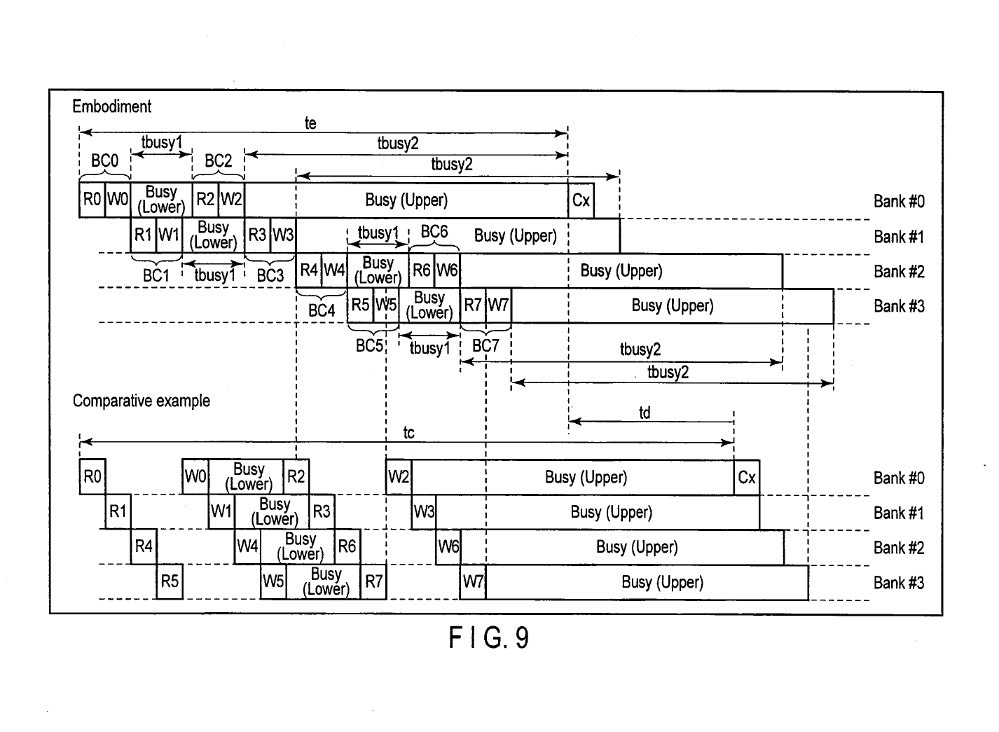

FIG. 8 and FIG. 9 each show a first example in which a bound command serving as a unit of an interleave operation is created by a read command and write command forming a pair.

Read commands R0 and R2, write commands W0 and W2, and a following command Cx are each queued in CQP #0; read commands R1 and R3, and write commands W1 and W3 are each queued in CQP #1; read commands R4 and R6, and write commands W4 and W6 are each queued in CQP #2; and, further, read commands R5 and R7, and write commands W5 and W7 are each queued in CQP #3.

The order of registration of these commands in the command queuing part is, for example, R0, W0, R1, W1, R2, W2, R3, W3, R4, W4, R5, W5, R6, W6, R7, W7 and Cx.

In CQP #0, a bound command BC0 is created by the two commands R0 and W0, and a bound command BC2 is created by the two commands R2 and W2. In CQP #1, a bound command BC1 is created by the two commands R1 and W1, and a bound command BC3 is created by the two commands R3 and W3.

In CQP #2, a bound command BC4 is created by the two commands R4 and W4, and a bound command BC6 is created by the two commands R6 and W6. In CQP #3, a bound command BC5 is created by the two commands R5 and W5, and a bound command BC7 is created by the two commands R7 and W7.

First, bank #0 is selected and bound command BC0 is transferred to bank #0. In bank #0, commands R0 and W0 are consecutively executed. Here, write command W0 is, for example, a command to write a lower bit of a multilevel NAND flash memory, and the busy time (execution time) thereof is tbusy1. Thus, during busy time tbusy1, bank #1 is selected and bound command BC1 is transferred to bank #1.

However, it is assumed that the transfer time of bound command BC1 is less than or equal to busy time tbusy1 of write command W0.

In this case, it is possible to conceal busy time tbusy1 of write command W0 in bank #0 by the transfer time for transfer of bound command BC1 to bank #1.

Next, when bound command BC1 is transferred to bank #1, commands R1 and W1 are consecutively executed in bank #1. Here, write command W1 is, for example, a command to write a lower bit of a multilevel NAND flash memory, and the busy time thereof is tbusy1. Thus, during busy time tbusy1, bank #0 is selected again and bound command BC2 is transferred to bank #0.

However, it is assumed that the transfer time of bound command BC2 is less than or equal to busy time tbusy1 of write command W1.

In this case, it is possible to conceal busy time tbusy1 of write command W1 in bank #1 by the transfer time for transfer of bound command BC2 to bank #0.

Next, when bound command BC2 is transferred to bank #0, commands R2 and W2 are consecutively executed in bank #0. Here, write command W2 is, for example, a command to write an upper bit of a multilevel NAND flash memory, and the busy time thereof is tbusy2. In the NAND flash memory, busy time tbusy2 occurring in writing an upper bit is longer than busy time tbusy1 occurring in writing a lower bit.

Thus, during this busy time tbusy2, bank #1 is selected again and bound command BC3 is transferred to bank #1.

However, it is assumed that the transfer time of bound command BC3 is less than or equal to busy time tbusy2 of write command W2.

In this case, it is possible to conceal busy time tbusy2 of write command W2 in bank #0 by the transfer time for transfer of bound command BC3 to bank #1.

Next, when bound command BC3 is transferred to bank #1, commands R3 and W3 are consecutively executed in bank #1. Here, write command W3 is, for example, a command to write an upper bit of a multilevel NAND flash memory, and a busy time thereof is tbusy2. Busy time tbusy2 is, as described above, longer than busy time tbusy1.

Thus, during this busy time tbusy2, bank #2 is selected and bound command BC4 is transferred to bank #2.

However, it is assumed that the transfer time of bound command BC4 is less than or equal to busy time tbusy2 of write command W3.

In this case, it is possible to conceal busy time tbusy2 of write command W3 in bank #1 by the transfer time for transfer of bound command BC4 to bank #2.

It should be noted that after bound command BC4 is transferred to bank #2, an operation identical to the above-mentioned interleave operation is applied to transfer of bound commands BC4, BC5, BC6 and BC7 to banks #2 and #3.

According to the interleave operation described above, as is evident from FIG. 9, it is possible to minimize in, for example, bank #0, time te from transfer of bound command BC0 to completion of execution of write command W2 to the utmost. Accordingly, it is possible to advance the timing of transfer of the following command Cx to bank #0. That is, according to the embodiment, time te is less than time tc from transfer of read command R0 to completion of execution of write command W2 in the comparative example by time td.

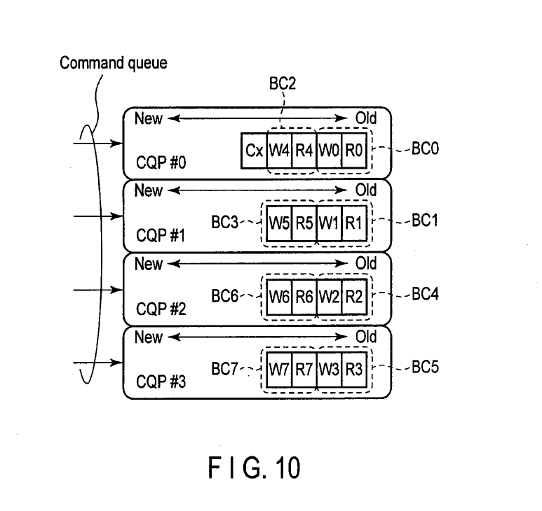

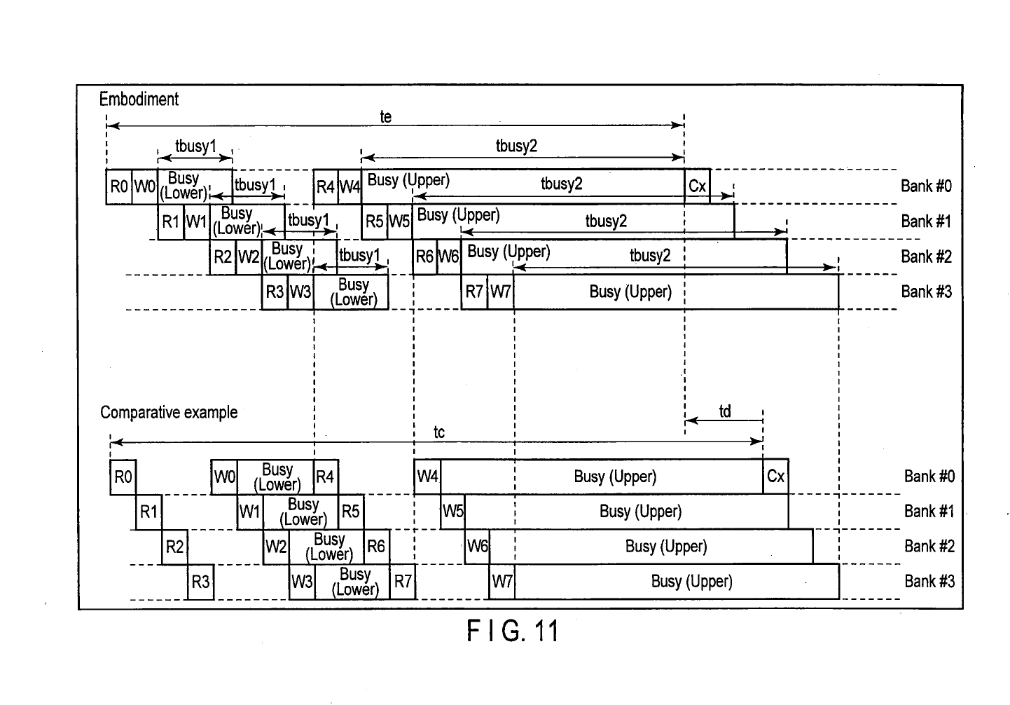

FIG. 10 and FIG. 11 each show a second example in which a bound command serving as a unit of an interleave operation is created by a read command and write command forming a pair.

In comparison with the first example, the second example is characterized in that the second example differs in the method of apportioning read commands R0 to R7 and write commands W0 to W7 among the command queuing parts CQP #0 to #3. As a result, the second example differs from the first example in the order of executing the interleave operation.

That is, read commands R0 and R4, write commands W0 and W4 and following command Cx are each queued in CQP #0, read commands R1 and R5 and write commands W1 and W5 are each queued in CQP #1, read commands R2 and R6 and write commands W2 and W6 are each queued in CQP #2, and read commands R3 and R7 and write commands W3 and W7 are each queued in CQP #3.

Even when the method of apportioning read commands R0 to R7 and write commands W0 to W7 among command queuing parts CQP #0 to #3 is changed as described above, it is possible, by creating bound commands BC0 to BC7, as in the first example, to make time to from transfer of bound command BC0 to completion of execution of write command W2 shorter, and make the timing of transfer of the following command Cx to bank #0 earlier than in the comparative example.

However, each of write commands W0 to W3 is, for example, a command to write a lower bit of a multilevel NAND flash memory, and the busy time (execution time) thereof is tbusy1.

Further, each of write commands W4 to W7 is, for example, a command to write an upper bit of a multilevel NAND flash memory, and the busy time (execution time) thereof is tbusy2.

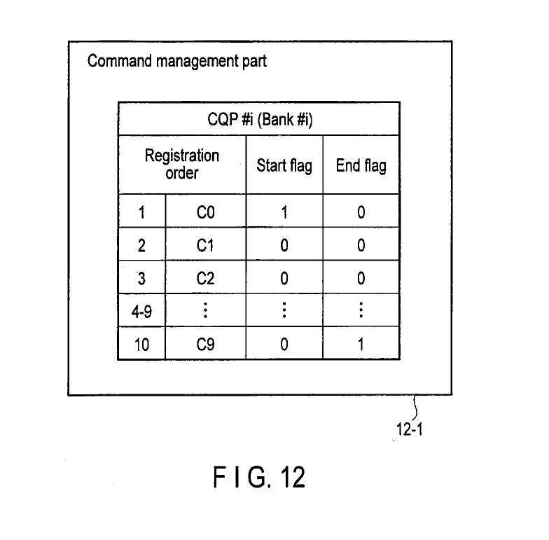

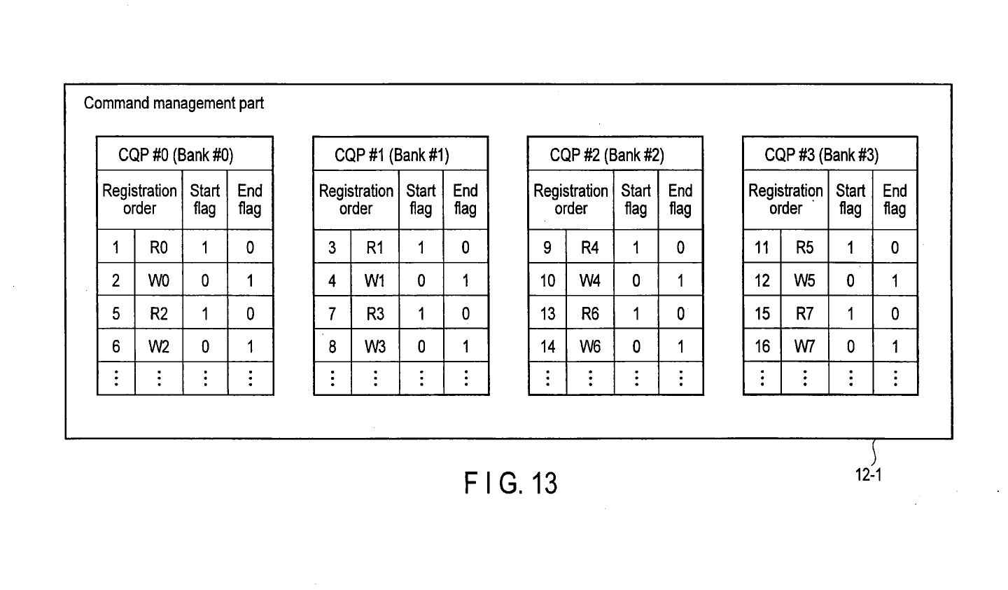

FIG. 12 shows an example in which a bound command is created by the command management part.

The command management part 12-1 creates a bound command on the basis of the registration order of a plurality of commands C0 to C9 in the command queuing part. For that purpose, the command management part 12-1 is provided with a storage part configured to store therein the registration order of each command in the command queuing part, a start flag indicating a start command in the bound command, and an end flag indicating an end command in the bound command.

For example, when a plurality of commands C0, C1, C2, . . . , C9 are consecutively registered in CQP #i (i is one of 0 to 3), the plurality of commands are put together, thereby creating one bound command.

At this time, the start flag of the first registered command C0 is set (logical 1). Further, regarding the plurality of commands C1 to C8 subsequent to command C0, both the start and end flags are cleared (logical 0). Furthermore, the end flag of the last registered command C9 is set (logical 1).

Thereby, it is possible to consecutively execute the plurality of commands C0 to C9 according to the registration order in the command queuing part and, at the same time, collectively transfer the plurality of commands C0 to C8 to bank #i as a bound command.

FIG. 13 shows a state of the command management part corresponding to the example of FIG. 8 and FIG. 9.

Commands R0, W0, R2 and W2 of the registration order numbers 1, 2, 5 and 6 are queued in CQP #0. The registration order numbers of commands R0 and W0 are consecutive numbers, and the registration numbers of commands R2 and W2 are consecutive numbers, the start flag of each of commands R0 and R2 is set (logical 1), and the end flag of each of commands W0 and W2 is set (logical 1).

Commands R1, W1, R3 and W3 of the registration order numbers 3, 4, 7 and 8 are queued in CQP #1. The registration order numbers of commands R1 and W1 are consecutive numbers, and the registration numbers of commands R3 and W3 are consecutive numbers, the start flag of each of commands R1 and R3 is set (logical 1), and the end flag of each of commands W1 and W3 is set (logical 1).

Commands R4, W4, R6 and W6 of the registration order numbers 9, 10, 13 and 14 are queued in CQP #2. The registration order numbers of commands R4 and W4 are consecutive numbers, and the registration numbers of commands R6 and W6 are consecutive numbers, the start flag of each of commands R4 and R6 is set (logical 1), and the end flag of each of commands W4 and W6 is set (logical 1).

Commands R5, W5, R7 and W7 of the registration order numbers 11, 12, 15 and 16 are queued in CQP #3. The registration order numbers of commands R5 and W5 are consecutive numbers, and the registration numbers of commands R7 and W7 are consecutive numbers, the start flag of each of commands R5 and R7 is set (logical 1), and the end flag of each of commands W5 and W7 is set (logical 1).

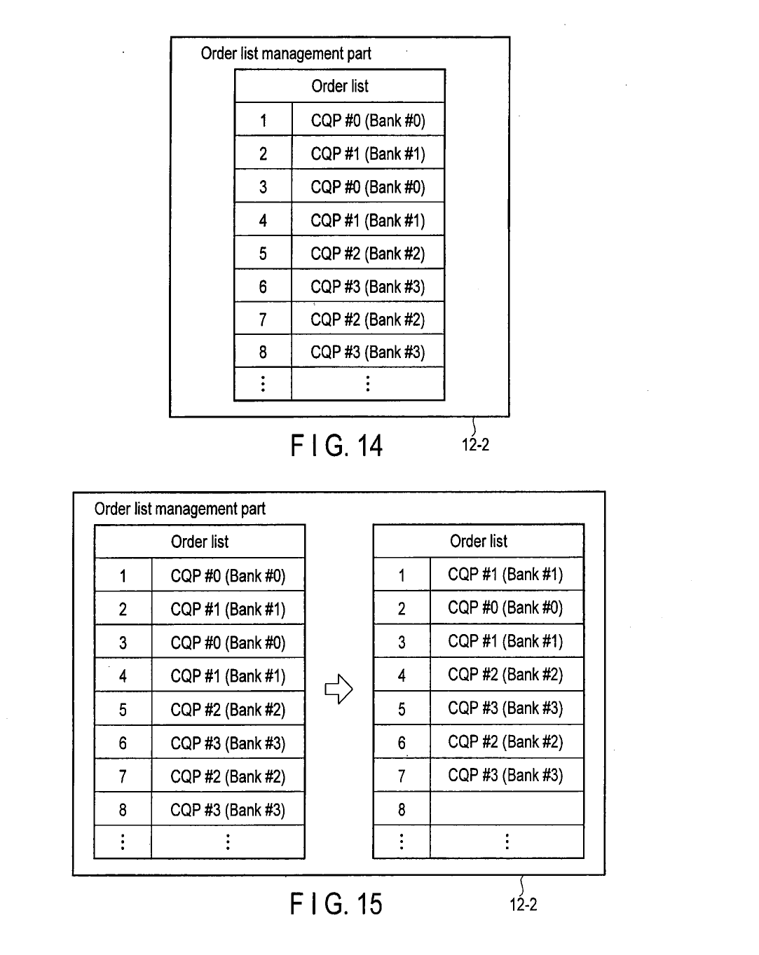

FIG. 14 shows the order list management part. The order list management part 12-2 manages the order of executing the interleave operation, for example, the order of transferring the bound command created by the command management part to banks #0, #1, #2 and #3.

FIG. 14 corresponds to the examples of FIG. 8, FIG. 9 and FIG. 13.

The order list is formed in such a manner that the first item is CQP #0 (bank #0), second item is CQP #1 (bank #1), third item is CQP #0 (bank #0), fourth item is CQP #1 (bank #1), fifth item is CQP #2 (bank #2), . . . .

For example, when transfer of a command from CQP #0 to bank #0 is to be carried out according to the order list, first, the controller confirms the start flag and end flag of the command in CQP #0. Further, the controller transfers the commands from command R0 the start flag of which is set (logical 1) to command W0 the end flag of which is set (logical 1) to bank #0 as bound command BC0. In bank #0, commands R0 and W0 are executed. Once execution of command W0 is complete, the fact is notified from bank #0 to the controller. On receiving of the notification indicating that execution of command W0 is complete, the controller confirms the end flag in the command management part. If the end flag of command W0 is set (logical 1), the controller deletes information about commands R0 and W0 from the command management part and deletes CQP #0 (bank #0) the order number of which is first from the order list.

As a result, the order list management part 12-2 is changed, as shown in FIG. 15, in such a manner that the first item is CQP #1 (bank 31), the second item is CQP #0 (bank #0), the third item is CQP #1 (bank #1), the fourth item is CQP #2 (bank #2), the fifth item is CQP #3 (bank #3), . . . .

As described above, according to the first embodiment, it is possible to improve the throughput in the memory system by making a bound command a unit of the interleave operation and controlling the order of the interleave operation.

### Second Embodiment

A second embodiment relates to an interleave operation to be carried out when a busy time occurs in a command other than the last command among the plurality of commands in the bound command described in the first embodiment.

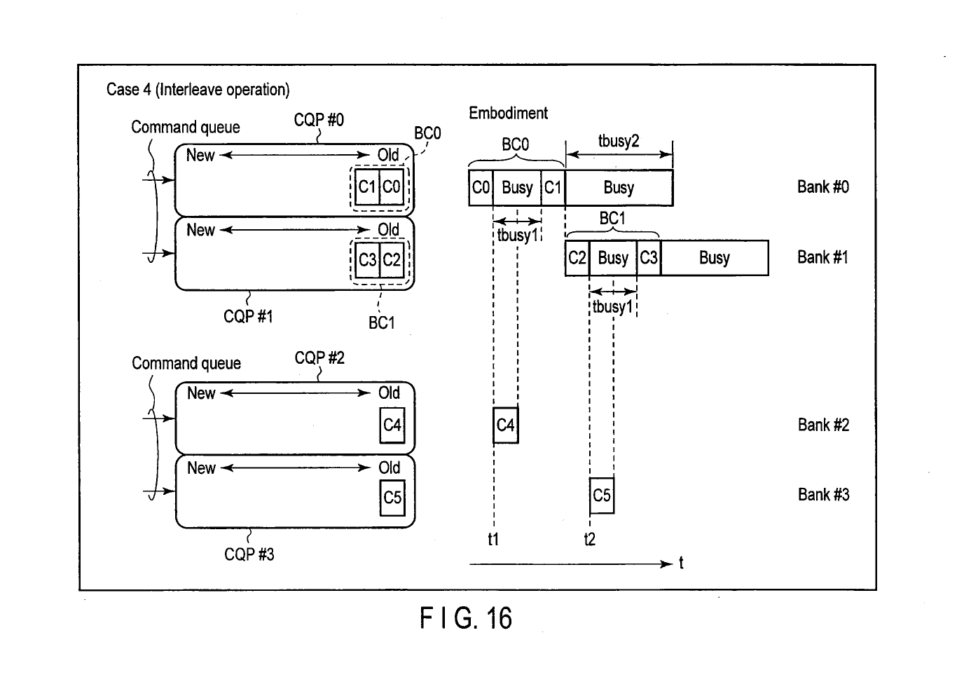

FIG. 16 shows a case 4 of the interleave operation.

In case 4, commands C0 and C1 are queued in CQP #0, commands C2 and C3 are queued in CQP #1, command C4 is queued in CQP #2, and command C5 is queued in CQP #3. The order of registration of these commands in the command queuing part is, for example, C0, C1, C2, C3, C4 and C5.

In CQP #0, a bound command BC0 is created by two commands C0 and C1. In CQP #1, a bound command BC1 is created by two commands C2 and C3.

In case 4, first, bank #0 is selected and bound command BC0 is transferred to bank #0. In bank #0, commands C0 and C1 are consecutively executed. Here, the point in which case 4 differs from case 1 (FIG. 5) is that a busy time (execution time) tbusy1 of the first command C0 in bound command BC0 occurs.

Thus, in order to conceal busy time tbusy1, transfer of a command to a bank other than bank #0 is executed during this busy time tbusy1.

Here, bank #0 is a bank in which the bound command is currently being executed and hence is called a current bank, and a bank in which a command is executed during execution of the bound command in bank #0 by acceleration for overtaking bank #0 is called an acceleration bank.

For example, during busy time tbusy1 of command C0, switching from bank #0 (current bank) to bank #2 (acceleration bank) is carried out and command C4 in CQP #2 is transferred to bank #2.

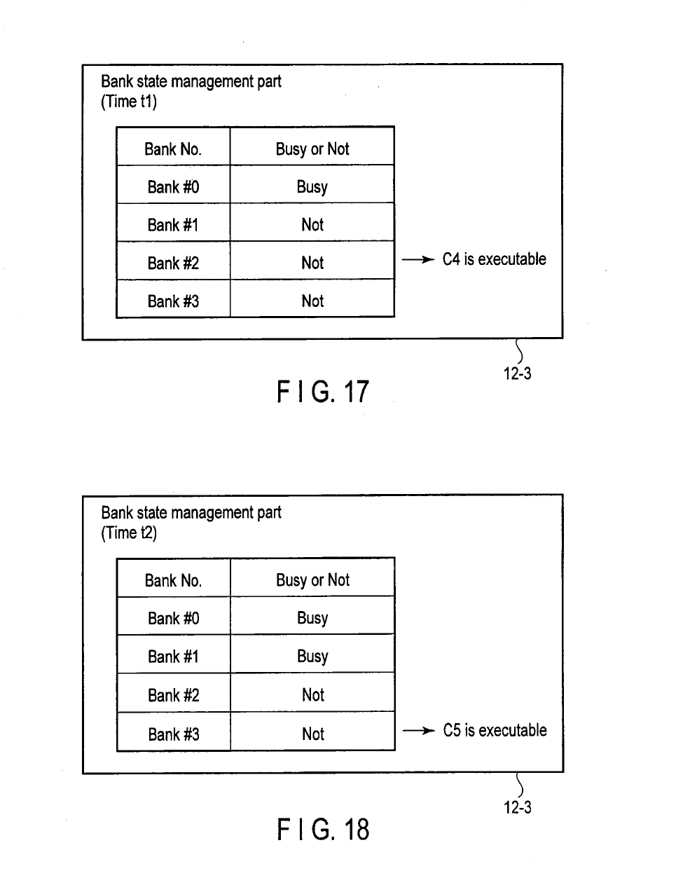

However, it is assumed that the transfer time of command C4 is shorter than busy time tbusy1 of command C0. Further, it is assumed, as shown in FIG. 17, that at time t1, at which time transfer of command C0 is completed, at least bank #2 which is to receive command C4 is ready (not busy).

Once transfer of command C4 to bank #2 is complete, switching from bank #2 (acceleration bank) to bank #0 (current bank) is carried out. Further, the last command C1 in bound command BC0 in CQP #0 is transferred to bank #0 and command C1 is executed in bank #0.

Further, during busy time tbusy2 of command C1, switching from bank #0 to bank #1 is carried out and bound command BC1 in CQP #1 is transferred to bank #1. In bank #1, commands C2 and C3 are consecutively executed.

Here, the point in which case 4 differs from case 1 (FIG. 5) is that busy time (execution time) tbusy1 of the first command C2 in bound command BC1 occurs.

Thus, in order to conceal busy time tbusy1, transfer of a command to a bank other than bank #1 is executed during busy time tbusy1. For example, switching from bank #1 (current bank) to bank #3 (acceleration bank) is carried out during busy time tbusy1 of command C2, and command C5 in CQP #3 is transferred to bank #3.

However, it is assumed that the transfer time of command C5 is shorter than busy time tbusy1 of command C2. Further, it is assumed, as shown in FIG. 18, that at time t2, at which time transfer of command C2 is completed, at least bank #3 which is to receive command C5 is ready (not busy).

Once transfer of command C5 to bank #3 is complete, switching from bank #3 (acceleration bank) to bank #1 (current bank) is carried out. Further, command C3 in CQP #1 is transferred to bank #1.

It should be noted that in case 4, each of commands C4 and C5 means a command which is not a member of a bound command, i.e., one single command.

The one single command may be a command not used as a member of a bound command or may be one of a plurality of commands used as a bound command.

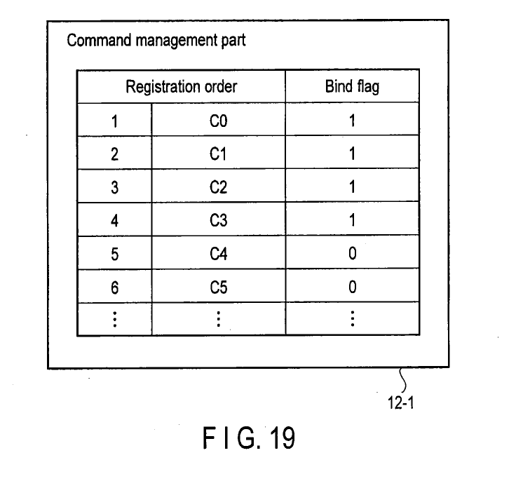

In the former case, as shown in FIG. 19, the command management part 12-1 may be provided with a bind flag indicating whether or not the plurality of commands C0, C1, C3, . . . queued in the command queuing part are used as a bound command.

Further, in the latter case, for example, once execution of commands C4 and C5 is complete, the command management part creates a new bound command from which commands C4 and C5 are excluded.

As described above, according to case 4, even when a busy time occurs in a command other than the last command among the plurality of commands in the bound command, it is possible to conceal the busy time thereof, and hence it is possible to contribute to improvement of the throughput of the memory system.

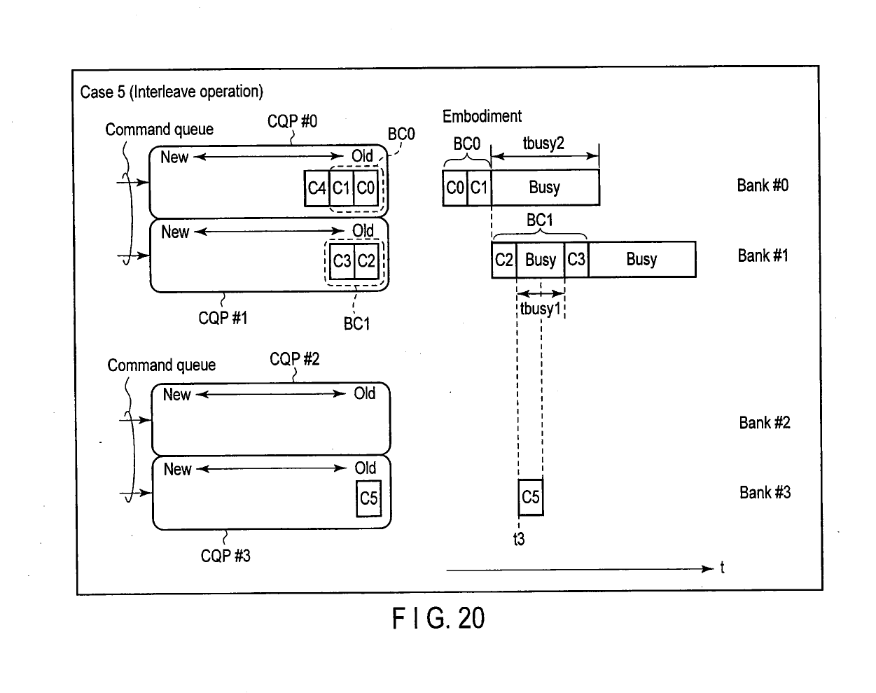

FIG. 20 shows a case 5 of the interleave operation.

Case 5 is a modification example of case 4.

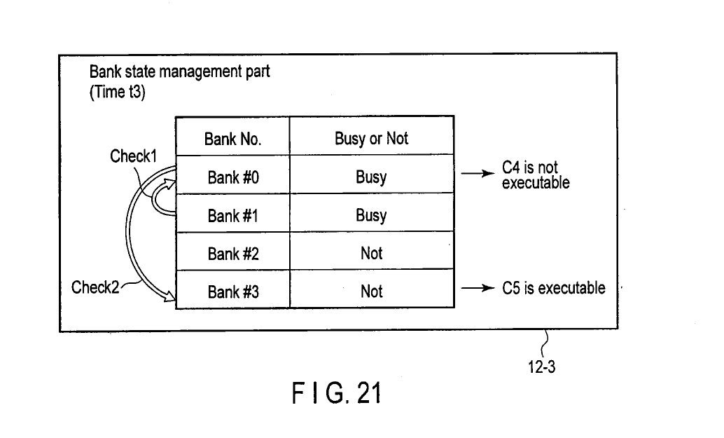

The point in which case 5 differs from case 4 is that command C4 is registered in CQP #0. In this case, as shown in FIG. 21, the state of bank #0 intended for reception of a command (oldest command) whose registration order number is the earliest among a plurality of commands for which transfer to a bank is not yet complete at time t3, at which time transfer of command C2 is completed, i.e., command C4, is confirmed (check 1).

In this example, at time t3, bank #0 is busy and hence, subsequently, bank #0 is skipped, and the state of bank #3 intended for reception of a command whose registration order number is next to command C4 among a plurality of commands for which transfer to a bank is not yet complete, i.e., command C5, is confirmed (check 2).

In this example, at time t3, bank #3 is ready (not busy).

Thus, for example, during busy time tbusy1 of command C2, switching from bank #1 (current bank) to bank #3 (acceleration bank) is carried out and command C5 in CQP #3 is transferred to bank #3.

However, it is assumed that the transfer time of command C5 is shorter than busy time tbusy1 of command C2.

Once the transfer of command C5 to bank #3 is complete, switching from bank #3 (acceleration bank) to bank #1 (current bank) is carried out. Further, command C3 in CQP #1 is transferred to bank #1.

As described above, in case 5 too, as in case 4, even when a busy time occurs in a command other than the last command among the plurality of commands in the bound command, it is possible to conceal the busy time thereof, and hence it is possible to contribute to improvement of the throughput of the memory system.

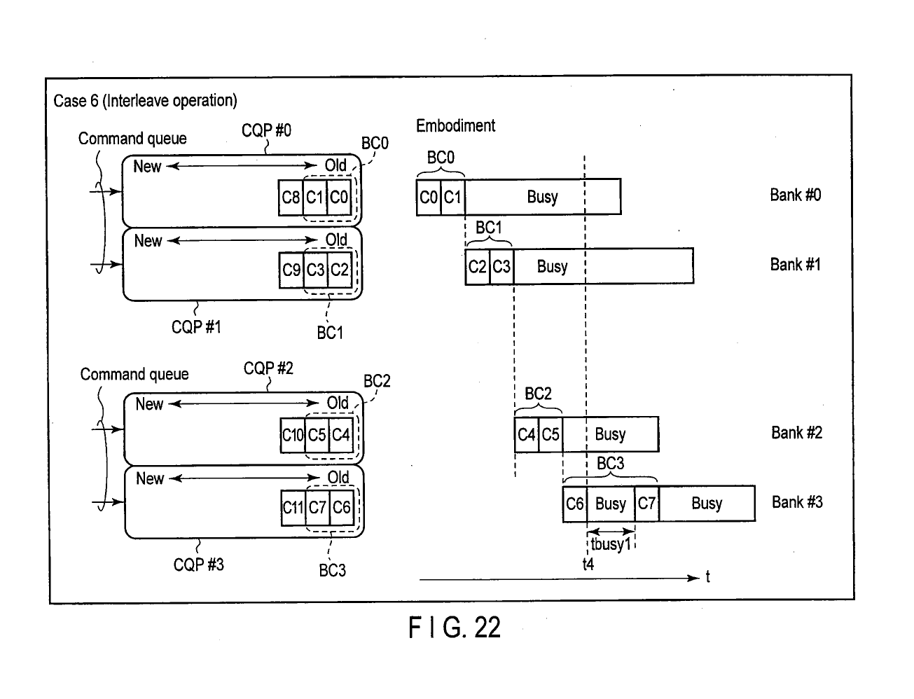

FIG. 22 shows a case 6 of the interleave operation.

In case 6, commands C0, C1 and C8 are queued in CQP #0, commands C2, C3 and C9 are queued in CQP #1, commands C4, C5 and C10 are queued in CQP #2, and commands C6, C7 and C11 are queued in CQP #3. The order of registration of these commands in the command queuing part is, for example, C0, C1, C2, C3, C4, C5, C6, C7, C8, C9, C10 and C11.

In CQP #0, a bound command BC0 is created by two commands C0 and C1, and in CQP #1, a bound command BC1 is created by two commands C2 and C3. In CQP #2, a bound command BC2 is created by two commands C4 and C5, and in CQP #3, a bound command BC3 is created by two commands C6 and C7.

In case 6, transfer of bound command BC0 to bank #0, transfer of bound command BC1 to bank #1, transfer of bound command BC2 to bank #2, and transfer of bound command BC3 to bank #3 are consecutively carried out.

Here, in case 6, a busy time (execution time) tbusy1 occurs in the first command C6 in bound command BC3.

Thus, in order to conceal busy time tbusy1, transfer of a command to a bank other than bank #3 is attempted during busy time tbusy1.

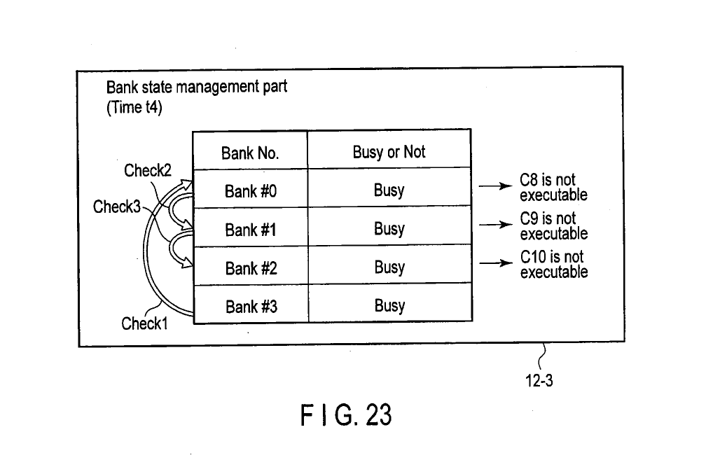

First, as shown in FIG. 23, at time t4, at which time transfer of command C6 is completed, the state of bank #0 intended for reception of a command (oldest command) whose registration order number is the earliest among a plurality of commands for which transfer to a bank is not yet complete, i.e., command C8, is confirmed (check 1).

In this example, at time t4, bank #0 is busy and hence, subsequently, bank #0 is skipped, and the state of bank #1 intended for reception of a command whose registration order number is next to command C8 among a plurality of commands for which transfer to a bank is not yet complete, i.e., command C9, is confirmed (check 2).

In this example, at time t4, bank #1 is busy and hence, subsequently, bank #1 is skipped, and the state of bank #2 intended for reception of a command whose registration order number is next to command C9 among a plurality of commands for which transfer to a bank is not yet complete, i.e., command C10, is confirmed (check 3).

In this example, at time t4, bank #2 is busy.

Accordingly, the controller determines that no bank to which a command can be transferred during busy time tbusy1 of command C6 exists, and hence switching from bank #3 (current bank) to another bank is never carried out during busy time tbusy1 thereof.

Further, after busy time tbusy1 of command C6 has elapsed, command C7 in CQP #3 is transferred to bank #3.

As described above, in case 6, when a command other than the last command among the plurality of commands in the bound command is to be executed in the current bank, no acceleration bank to which a command can be transferred during the busy time of the command exists, and hence, subsequently, execution of a command in the current bank is continued. Even in such a case, in comparison with the conventional case in which no bound command is used, it is possible to contribute to improvement of the throughput of the memory system.

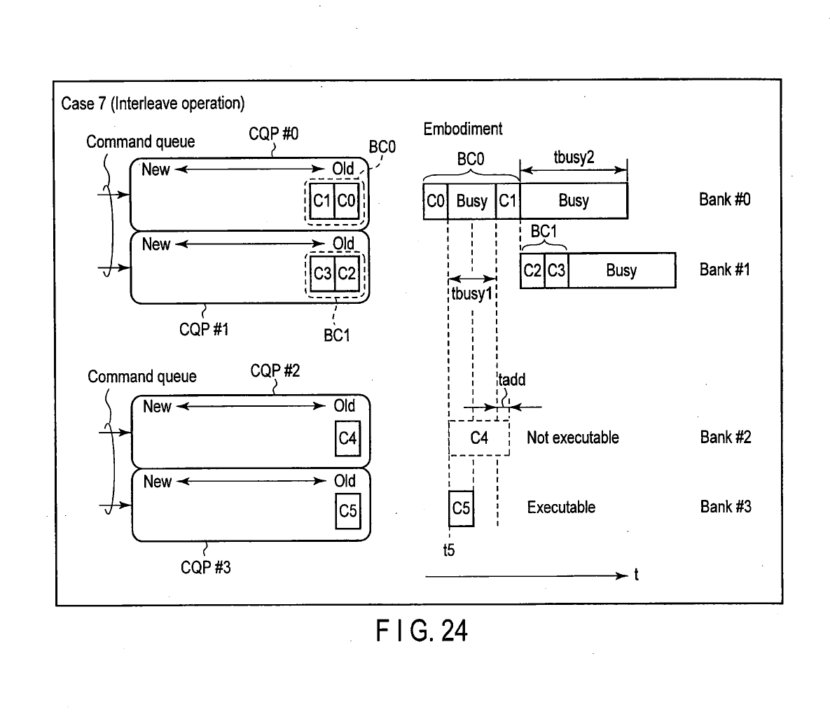

FIG. 24 shows a case 7 of the interleave operation.

Case 7 is a modification example of case 4.

The point in which case 7 differs from case 4 is that the transfer time for transfer of command C4 to bank #2 is longer than busy time tbusy1 of command C0 in bound command BC0. In this case, as in case 4, when command C4 is transferred to bank #2 (acceleration bank), the transfer time for transferring bound command BC0 to bank #0 (current bank) increases.

That is, command C1 in bound command BC0 is transferred to bank #0 once the transfer of command C4 to bank #2 is complete, and hence, as a result, transfer of command C1 in bound command BC0 is delayed from case 4 by time tadd. This reduces the throughput of the memory system in some cases.

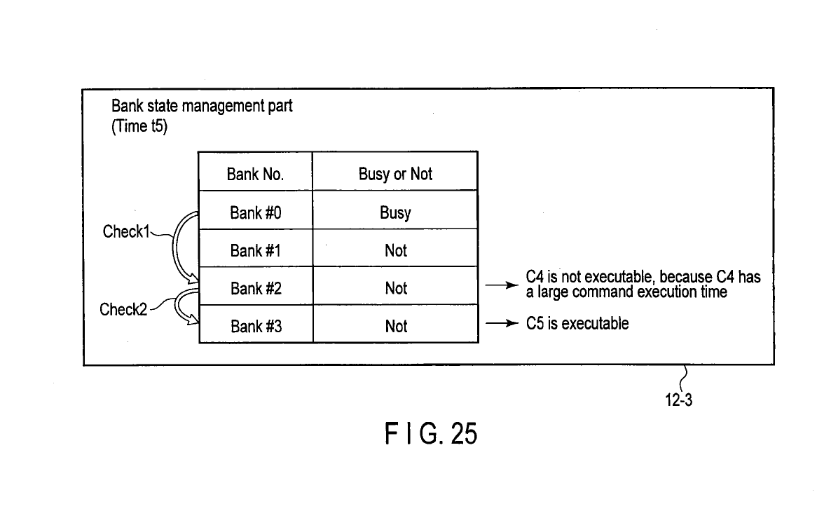

Thus, in this case, as shown in FIG. 25, at time t5, at which time transfer of command C0 is completed, the transfer time of a command (oldest command) whose registration order number is the earliest among a plurality of commands for which transfer to a bank is not yet complete, i.e., command C4, is confirmed. The transfer time of command C4 can be confirmed according to, for example, the type of command C4 (check 1).

In this example, the transfer time of command C4 is longer than busy time tbusy1 and hence, subsequently, bank #2 is skipped, and the transfer time of a command whose registration order number is next to command C4 among a plurality of commands for which transfer to a bank is not yet complete, i.e., command C5, is confirmed. The transfer time of command C5 can be confirmed according to, for example, the type of command C5 (check 2).

In this example, the transfer time of command C5 is shorter than busy time tbusy1.

Thus, for example, during busy time tbusy1 of command C0, switching from bank #0 (current bank) to bank #3 (acceleration bank) is carried out and command C5 in CQP #3 is transferred to bank #3.

Once the transfer of command C5 to bank #3 is complete, switching from bank #3 (acceleration bank) to bank #0 (current bank) is carried out. Further, command C1 in CQP #0 is transferred to bank #0.

As described above, in case 7 too, as in case 4, even when a busy time occurs in a command other than the last command among the plurality of commands in the bound command, it is possible to conceal the busy time thereof, and hence it is possible to contribute to improvement of the throughput of the memory system.

### Third Embodiment

A third embodiment relates to an example of an interleave operation in which when a busy time occurs in a command other than the last command among a plurality of commands in a bound command described in the second embodiment, the type of a command which can be transferred within the busy time is determined according to the type (busy time) of the command.

(1) When a busy time occurs in a current bank because of execution of a write command, the busy time of the write command is expressed by, for example, tprg as shown in FIG. 2. Busy time tprg is the longest among the execution times of the commands, and hence when busy time tprg occurs, it is assumed that the commands which can be transferred within busy time tprg are all the commands.

For example, when a busy time tprg of a write command occurs in the current bank, it is possible to transfer a read command, a compaction read command, an erase command, a reset command, a write command and the like to an acceleration bank within busy time tprg.

Here, in FIG. 2, the write command, address and DATA IN constitute the first half command of the write command, and status constitutes the second half command. DATA IN is a command accompanying data input. Here, each of the first half command and second half command of the write command is a command which can be transferred within busy time tprg.

Further, in FIG. 3, the read command and address constitute the first half command of the read command, and DATA OUT constitutes the second half command. DATA OUT is a command accompanying data Output. Here, each of the first half command and second half command of the read command is a command which can be transferred within busy time tprg.

(2) When a busy time occurs in the current bank because of execution of a read command, the busy time of the read command is expressed by, for example, tr as shown in FIG. 3. Busy time tr is shorter than busy time tprg of the write command, and hence when busy time tr occurs, it is assumed that commands which can be transferred within busy time tr are commands other than DATA IN.

Here, DATA IN implies, for example, the first half command (write command, address and DATA IN) of the write command shown in FIG. 2.

Accordingly, each of the second half command (status) of the write command of FIG. 2, first half command (read command and address) of the read command of FIG. 3, and second half command (DATA OUT) is a command which can be transferred within busy time tr.

However, regarding the second half command (DATA OUT) of the read command, if the transfer time of DATA OUT is shorter than busy time tr, for example, when the transfer amount of DATA OUT is small, the second half command is made a transferable command and, if the transfer time of DATA OUT is longer than busy time tr, for example, when the transfer amount of DATA OUT is large, the second half command is not made a transferable command.

As described above, the reason for making the commands which can be transferred within busy time tr the commands other than DATA IN is that the transfer time of data based on DATA IN is longer than busy time tr of the read command.

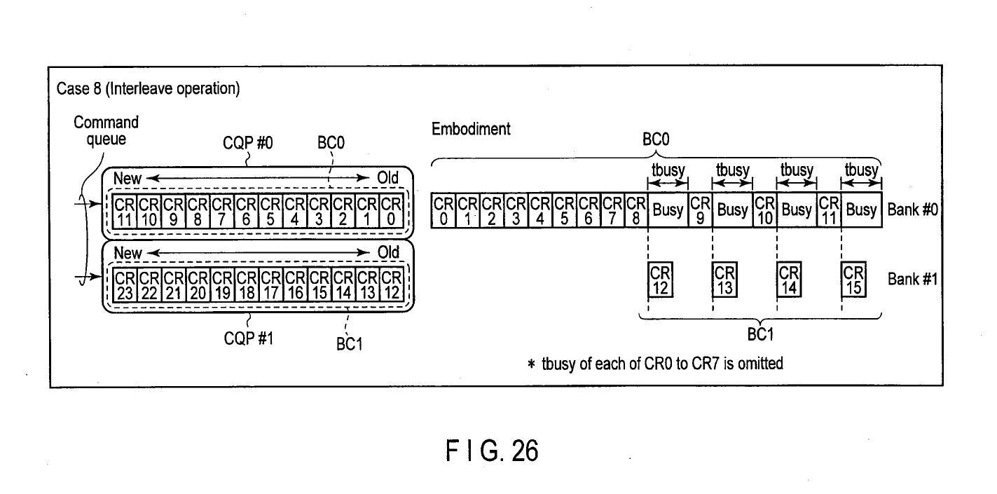

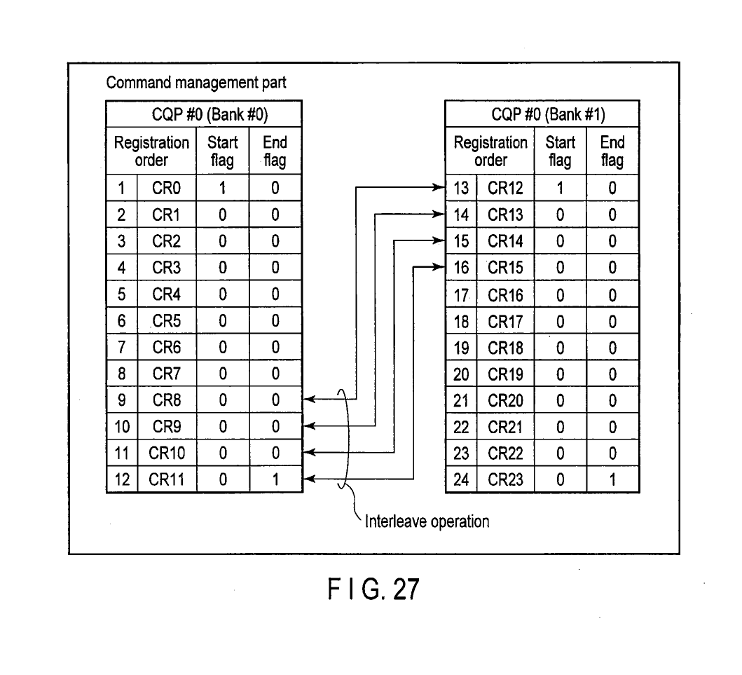

FIG. 26 and FIG. 27 each show a case 8 of the interleave operation.

Case 8 is an example in which, when a busy time tr occurs during execution of a plurality of compaction read commands in the current bank, one compaction read command is transferred in an acceleration bank.

In case 8, compaction read commands CR0 to CR11 are queued in CQP #0. In CQP #0, a bound command BC0 is created by these commands CR0 to CR11.

Further, compaction read commands CR12 to CR23 are queued in CQP #1. In CQP #1, a bound command BC1 is created by these commands CR12 to CR23.

First, bank #0 is selected and bound command BC0 is transferred to bank #0. That is, compaction read commands CR12 to CR23 are consecutively transferred to bank #0. Here, during busy time tbusy of compaction read command CR8, switching from bank #0 (current bank) to bank #1 (acceleration bank) is carried out and compaction read command CR12 in bound command BC1 is transferred to bank #1.

Once the transfer of compaction read command CR12 to bank #1 is complete, switching from bank #1 (acceleration bank) to bank #0 (current bank) is carried out and compaction read command CR9 in bound command BC0 is transferred to bank #0.

Further, during busy time tbusy of compaction read command CR9, switching from bank #0 (current bank) to bank #1 (acceleration bank) is carried out and compaction read command CR13 in bound command BC1 is transferred to bank #1.

Once the transfer of compaction read command CR13 to bank #1 is complete, switching from bank #1 (acceleration bank) to bank #0 (current bank) is carried out and compaction read command CR10 in bound command BC0 is transferred to bank #0.

Likewise, during busy time tbusy of compaction read command CR10, compaction read command CR14 in bound command BC1 is transferred and, during busy time tbusy of compaction read command CR11, compaction read command CR15 in bound command BC1 is transferred.

As described above, by transferring one compaction read command in the acceleration bank during a busy time tr of a compaction read command in the current bank, it is possible to improve the throughput of the memory system.

It should be noted that in this example, transfer of a command accompanying data input, for example, transfer of the above-mentioned DATA IN is not carried out during a busy time tr of a compaction read command. This is because the transfer time of a command accompanying data input/output, for example, the transfer time of DATA IN/OUT is longer than busy time tr of the compaction read command.

### Fourth Embodiment

A fourth embodiment relates to a combination of the above-mentioned first to third embodiments.

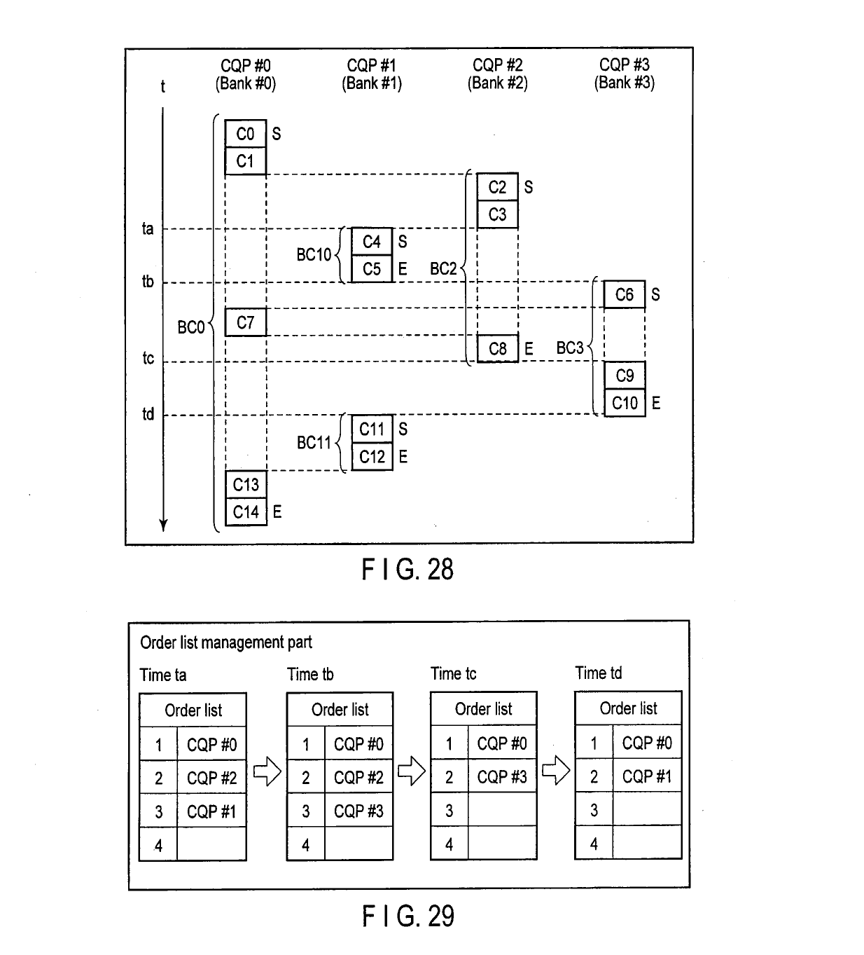

FIG. 28 shows an interleave operation according to the fourth embodiment.

A bound command BC0 includes a plurality of commands C0, C1, C7, C13 and C14 and is queued in CQP #0. Bound command BC0 starts with command C0 and ends with command C14.

A bound command BC10 includes a plurality of commands C4 and C5 and is queued in CQP #1. The bound command starts with command C4 and ends with command C5. A bound command BC11 includes a plurality of commands C11 and C12 and is queued in CQP #1. The bound command starts with command C11 and ends with command C12.

A bound command BC2 includes a plurality of commands C2, C3 and C8 and is queued in CQP #2. Bound command BC2 starts with command C2 and ends with command C8.

A bound command BC3 includes a plurality of commands C6, C9 and C10 and is queued in CQP #3. Bound command BC3 starts with command C6 and ends with command C10.

Here, in FIG. 28, “S” added to each series of commands indicates a command the start flag of which is set (logical 1) and “E” indicates a command the end flag of which is set (logical 1).

When the aforementioned interleave operation is executed, the order list management part changes as shown in FIG. 29.

That is, in the order list management part 12-2, the order list at time to is in a state where the first item is CQP #0, the second item is CQP #2 and the third item is CQP #1. Transfer and execution of bound command BC10 are completed at time tb, and hence the order list at time tb changes to a state where the first item is CQP #0, the second item is CQP #2 and the third item is CQP #3. Transfer and execution of bound command BC2 are completed at time tc, and hence the order list at time tc changes to a state where the first item is CQP #0 and the second item is CQP #3. Transfer and execution of bound command BC3 are completed at time td, and hence the order list at time td changes to a state where the first item is CQP #0 and the second item is CQP #1.

As described above, in the fourth embodiment too, it is possible to improve the throughput of the memory system.

### Fifth Embodiment

A fifth embodiment also relates to a combination of the aforementioned first to third embodiments.

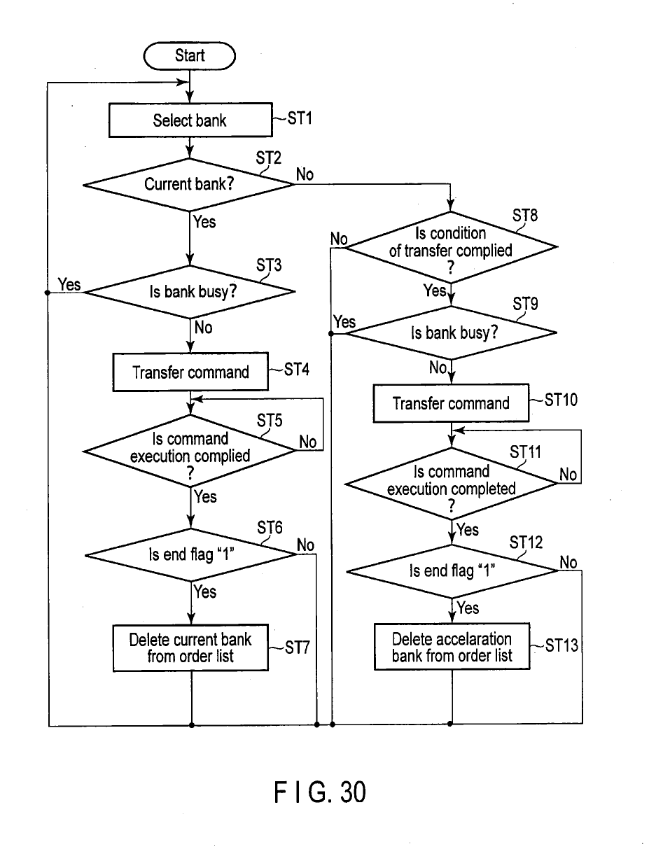

FIG. 30 shows a flowchart of an interleave operation according to the fifth embodiment.

First, a bank is selected (step ST1).

One of, for example, banks #0, #1, #2 and #3 is selected by a chip enable signal from the controller.

If the order list number of the selected bank (active bank) is first, this bank is the current bank. If the order list number of the selected bank is second or a subsequent number, this bank is the acceleration bank.

If the current bank is busy, a bank is selected out again in order to carry out an interleave operation (control passes from step ST3 to step ST1). The bank selected in this step is an acceleration bank, and step ST8 and subsequent steps are executed for the bank.

If the current bank is not busy, one of a plurality of commands included in the bound command is transferred to the selected bank (current bank) (step ST4). In the current bank, the one command is executed and the current bank becomes busy.

Once execution of the command has been completed in the current bank, it is confirmed whether or not the end flag of the command is set (logical 1) (control passes from step ST5 to step ST6).

If the end flag is clear (logical 0), a bank is selected again (control passes from step ST6 to step ST1). In this step, for example, the current bank is selected and the other one of the plurality of commands included in the bound command is transferred to the selected bank (current bank).

If the end flag is set (logical 1), the selected bank (current bank) is deleted from the order list (step ST7). Accordingly, the bank of the second item in the order list is raised to the first item, and hence the raised bank becomes the current bank.

If the order list number of the selected bank (active bank) is second or a subsequent number, this selected bank is an acceleration bank.

When the acceleration bank is selected, first it is confirmed whether or not the condition for transfer of a command to the acceleration bank is satisfied (step ST8).

For example, as described in connection with FIG. 24 and FIG. 25, if the transfer time of the command to be transferred to the acceleration bank is longer than the busy time of the current bank, the condition is not satisfied and hence a bank is selected again (control passes from step ST8 to step ST1).

Conversely, if the transfer time of the command to be transferred to the acceleration bank is shorter than the busy time of the current bank, the condition is satisfied and hence it is thereafter confirmed whether or not the acceleration bank is busy (step ST9).

If the acceleration bank is busy, a bank is selected again in order to carry out an interleave operation (control passes from step ST9 to step ST1). Here, as shown in FIG. 22 and FIG. 23, when all the acceleration banks are busy, the current bank is selected again in the bank selection step (step ST1).

If the acceleration bank is not busy, a command is transferred to the selected bank (acceleration bank) (step ST10). In the acceleration bank, the command is executed and the acceleration bank becomes busy.

Once the execution of the command is has been completed in the acceleration bank, it is confirmed whether or not the end flag of the command is set (logical 1) (control passes from step ST11 to step ST12).

If the end flag is clear (logical 0), a bank is selected again (control passes from step ST12 to step ST1).

If the end flag is set (logical 1), the selected bank (acceleration bank) is deleted from the order list (step ST13). Accordingly, banks each of which has an order number lower than that of the selected bank are each raised in order by one.

As described above, in the fifth embodiment too, it is possible to improve the throughput of the memory system.

### APPLICATION EXAMPLE

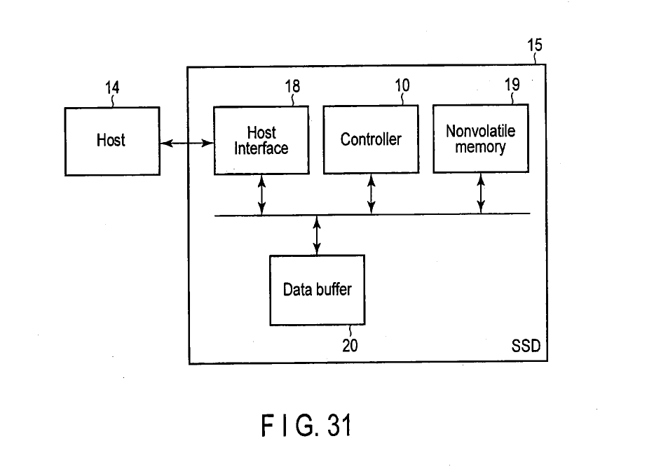

FIG. 31 shows an SSD as an application example.

An SSD 15 is provided with a host interface 18, a controller 10, a nonvolatile memory 19, and a data buffer 20. The SSD 15 is connected to a host 14 such as a personal computer or server. The SSD 15 functions as, for example, an external storage device of the host 14. The host interface 18 functions as an interface between the host 14 and SSD 15.

The nonvolatile memory 19 is, for example, a NAND flash memory. The data buffer 20 is, for example, a DRAM or magnetic random access memory (MRAM). That is, it is sufficient if the data buffer 20 is a random access memory of higher speed than the nonvolatile memory 19 serving as a storage memory.

The controller 10 controls an interleave operation according to the aforementioned first to fifth embodiments.

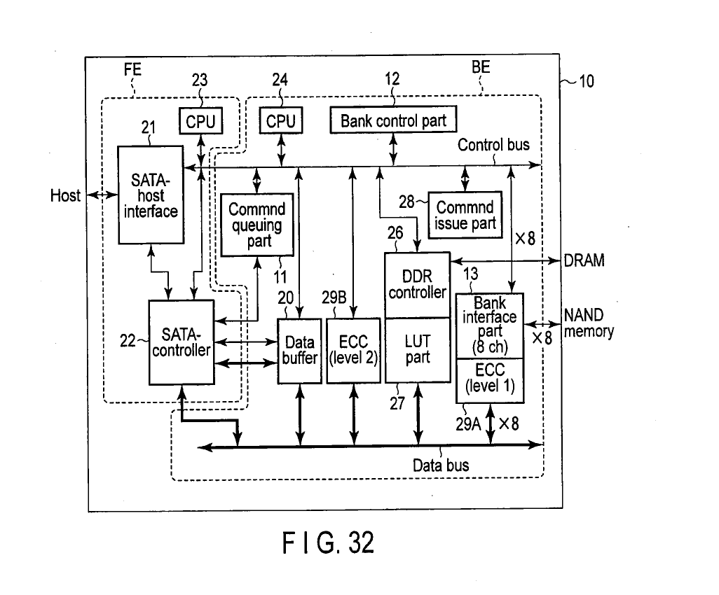

FIG. 32 shows an example of the controller 10 of FIG. 31.

The controller 10 is provided with a front-end part FE and back-end part BE.

The front-end part FE is provided with a front-end CPU 23 configured to control operations in the front-end part FE, SATA host interface 21 serving as an interface with the host, and SATA controller 22 configured to control data communication with the back-end part BE.

The back-end part BE is provided with a back-end CPU 24 configured to control operations in the back-end part BE, command queuing part 11 configured to queue a plurality of commands, data buffer (for example, SRAM) 20 configured to temporarily store data therein, command issue part 28 configured to issue a command, double data rate (DDR) controller 26 configured to control a DRAM serving as an external memory, LUT part 27 configured to temporarily store therein a lookup table read from a DRAM, bank interface part (NAND controller) 13 configured to control a NAND memory, and ECC circuits 29A and 29B configured to correct data of a NAND memory.

The bank interface part 13 includes, for example, eight channels. In this case, the bank interface part 13 can independently control eight NAND memories. The error correction function of the ECC circuit (level 2) 29B is superior to the error correction function of the ECC circuit (level 1) 29A. The ECC circuits 29A and 29B are appropriately used according to the status of use of the NAND memory.

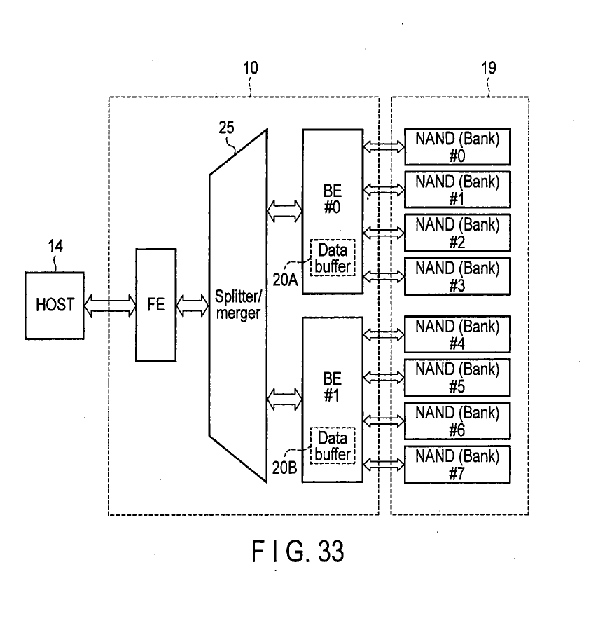

FIG. 33 shows the relationship between the front- and back-end parts.

The front-end part FE and back-end part BE are connected to each other via a splitter/merger 25. The splitter/merger 25 splits or merges data to be transferred from the host 14 to a memory device (for example, a NAND device) or data to be transferred from the memory device to the host 14.

The back-end part BE is provided with a first back end BE #0 and second back end BE #1. The first back end BE #0 is provided with a first data buffer 20A, and the second back end BE #1 is provided with a second data buffer 20B.

The first back end BE #0 carries out, for example, data communication (read/write) associated with a first command over the first data buffer 20A, and the second back end BE #1 carries out, for example, data communication (read/write) associated with a second command over the second data buffer 20B.

In this example, the controller 10 is provided with NANDs #0, #1, #2, #3, #4, #5, #6 and #7 constituting eight channels. NANDs #0, #1, #2 and #3 constituting four channels are connected to the first back end BE #0, and NANDs #4, #5, #6 and #7 constituting four channels are connected to the second back end BE #1.

As described above, according to the application example, it is possible to improve the performance of the SSD by virtue of the improvement of the throughput in the memory system.

### CONCLUSION

According to the first to fifth embodiments and the application example, the bound command is made a unit of the interleave operation and the order of execution of the interleave operation is controlled. As a result, the transfer time for transfer of a command to a bank is shortened, and even when the busy time of a bank is prominent, it is possible to effectively nullify the busy time by transfer of a command to a bank that is ready. Accordingly, it is possible to improve the throughput in the memory system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller comprising:
a first command queuing part corresponding to a first bank, the first command queuing part queuing commands, the first bank executing the commands queued in the first command queuing part;
a second command queuing part corresponding to a second bank, the second command queuing part queuing commands, the second bank executing the commands queued in the second command queuing part; and
a bank control part which is configured to:
generate a first bound command by binding at least two commands in the first command queuing part,
generate a second bound command by binding at least two commands in the second command queuing part,
transfer the first bound command as an unit of an interleave operation between the first and second banks to the first bank, and
transfer the second bound command as an unit of the interleave operation to the second bank.

2. The controller of claim 1, wherein
the bank control part is configured to transfer at least one command in the second bound command to the second bank during a busy time executing one command in the first bound command in the first bank.

3. The controller of claim 2, wherein
the bank control part is configured to transfer the commands in the second bound command to the second bank during the busy time.

4. The controller of claim 2, wherein
the busy time is an execution time of an end command in the first bound command.

5. The controller of claim 2, wherein
the busy time is an execution time of a command except an end command in the first bound command.

6. The controller of claim 2, wherein
the at least one command transferred to the second bank includes a command with a data input/output, when the busy time is an execution time of a write command.

7. The controller of claim 2, wherein
the at least one command transferred to the second bank is a command without a data input, when the busy time is an execution time of a read command.

8. The controller of claim 7, wherein
the at least one command transferred to the second bank includes a command with a data output when a transfer time of the command with the data output is equal to or shorter than the busy time as the execution time of the read command, and does not include the command with the data output when the transfer time of the command with the data output is longer than the busy time as the execution time of the read command.

9. The controller of claim 2, wherein
the first bank is a multi-level NAND flash memory capable of storing a lower bit and an upper bit in one memory cell, and
the busy time is an execution time of a write command of the lower bit or the upper bit.

10. The controller of claim 1, wherein
each of the first and second bound commands includes a read command and a write command following the read command.

11. The controller of claim 1, wherein
each of the first and second bound commands includes compaction read commands which is continuously aligned in one another.

12. The controller of claim 1, wherein
the bank control part comprises a command management part which manages a registration order of the commands to the first and second command queuing parts, and which generates the first and second bound commands based on the registration order.

13. The controller of claim 12, wherein
the command management part comprises a start flag showing a start command of the first bound command and an end flag showing an end command of the first bound command, and comprises a start flag showing a start command of the second bound command and an end flag showing an end command of the second bound command.

14. The controller of claim 1, wherein
the bank control part comprises an order list management part which manages an order of the interleave operation.

15. The controller of claim 1, wherein
the bank control part comprises a bank state management part which manages a state of the first and second banks, and
the bank control part is configured to transfer at least one command in the second bound command to the second bank during a busy time for executing one command in the first bound command in the first bank, when the second bank has a ready state in the bank state management part.

16. The controller of claim 1, wherein
the bank control part comprises a bank switching part which selects one of the first and second banks, the first bound command is transferred to the first bank when the first bank is selected, and the second bound command is transferred to the second bank when the second bank is selected.

17. The controller of claim 1, wherein
the bank control part is configured to not transfer one command in the second bound command to the second bank during a busy time executing one command in the first bound command in the first bank, when a transfer time to the second bank of the one command in the second bound command is larger than the busy time.

18. A solid state drive comprising:
a nonvolatile memory having a first bank and a second bank; and
a controller controlling an interleave operation between the first and second banks,
the controller comprising:
a first command queuing part corresponding to the first bank, the first command queuing part queuing commands, the first bank executing the commands queued in the first command queuing part;
a second command queuing part corresponding to the second bank, the second command queuing part queuing commands, the second bank executing the commands queued in the second command queuing part; and
a bank control part which is configured to:
generate a first bound command by binding at least two commands in the first command queuing part,
generate a second bound command by binding at least two commands in the second command queuing part,
transfer the first bound command as an unit of the interleave operation to the first bank, and
transfer the second bound command as an unit of the interleave operation to the second bank.

19. The solid state drive of claim 18, wherein
each of the first and second banks is NAND flash memory.

20. A control method comprising:
queuing commands in a first command queuing part, the first command queuing part corresponding to a first bank which is capable of executing the commands queued in the first command queuing part;
queuing commands in a second command queuing part, the second command queuing part corresponding to a second bank which is capable of executing the commands queued in the second command queuing part; and
generating a first bound command by binding at least two commands in the first command queuing part, generating a second bound command by binding at least two commands in the second command queuing part,
transferring the first bound command as an unit of an interleave operation between the first and second banks to the first bank, and
transferring the second bound command as an unit of the interleave operation to the second bank.
